(19) United States
(12) Patent Application Publication
(10) Pub. No.: US 2017/0185146 A1
(43) Pub. Date: Jun. 29, 2017

(54) VEHICLE NOTIFICATION SYSTEM INCLUDING TRANSPARENT AND MIRRORED DISPLAYS

(71) Applicant: Ford Global Technologies, LLC, Dearborn, MI (US)

(72) Inventors: Alexander Groh, Detroit, MI (US); Arun Dutta, Ann Arbor, MI (US); Ali Hassani, Ann Arbor, MI (US); Pol Llado, Canton, MI (US); Jakob Nikolaus Hoellerbauer, Canton, MI (US); Seth Avery, Livonia, MI (US)

(21) Appl. No.: 14/983,307

(22) Filed: Dec. 29, 2015

(51) Int. Cl. G06F 3/01; B60Q 9/00; B60R 1/00

(52) U.S. Cl. CPC G06F 3/013; B60R 1/00; B60Q 9/00

(57) ABSTRACT

Various embodiments of the present disclosure provide a vehicle notification system. The vehicle notification system includes at least one transparent display device, at least one mirror display device, and an eye tracker, and is configured to determine which display device the vehicle's driver is looking at and display notifications on that display device.

### TECHNICAL FIELD

The present disclosure generally relates to a vehicle notification system. More particularly, the vehicle notification system includes at least one transparent display device, at least one mirror display device, and an eye tracker, and is configured to determine which display device the vehicle's driver is looking at and display notifications on that display device.

### BACKGROUND

Certain known vehicles include vehicle notification systems that output notifications when certain conditions are met. For example, one known vehicle notification system outputs a chime via the vehicle's speakers when the vehicle's rear bumper nears an object. Another known vehicle notification system lights up an indicator on the dashboard when the amount of gas in the vehicle's gas tank falls below a particular amount.

These known vehicle notification systems do not optimize their presentation of the notification to maximize the chances that the driver recognizes and understands the notification. This increases the chances that the driver will overlook the notification. For instance, a vehicle's dashboard includes a plethora of lights and instruments, and the driver may not notice that one light (of many) has turned on. And if the vehicle's radio is on, the driver may not hear an accompanying auditory notification. Further, these known vehicle notification systems do not present the visual notifications in the driver's field-of-view. This requires the driver to take his eyes off the road whenever a light turns on or the infotainment system displays a textual message to determine what the notification is and how he should respond. These known vehicle notification systems also fail to indicate the source of the notification, requiring the driver to spend time to do so himself.

There is a need for new vehicle notification systems that solve these problems.

### SUMMARY

The appended claims define this application. The specification summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Exemplary embodiments provide a vehicle notification system including at least one transparent display device, at least one mirror display device, and an eye tracker, and is configured to determine which display device the vehicle's driver is looking at and display notifications on that display device.

According to one embodiment, a vehicle notification system comprises a transparent display, a mirror display, an eye tracker, and a controller. The controller is configured to: determine which display a vehicle driver is looking at using the eye tracker; control that display to display a notification and, if a notification source is viewable via that display, control that display to indicate the source; and if the driver begins looking at another display, control the other display to display the notification.

According to another embodiment, the controller is also configured to, if the source is not viewable via the display the driver is looking at, control the display the driver is looking at to display an indication associated with a location of the source.

According to another embodiment, the controller is also configured to control the display the driver is looking at to display a suggested action to take to respond to the notification. The controller may determine the suggested action based at least in part on sensor feedback.

According to another embodiment, a method of operating a vehicle notification system comprises: determining, by a controller and based on information obtained using an eye tracker, whether a vehicle driver is looking at a transparent display or a mirror display; displaying a notification on that display and, if a notification source is viewable via that display, indicating the source using that display; and if the driver begins looking at another display, displaying the notification on the other display.

According to another embodiment, the method also includes displaying an indication associated with a location of the source on the display the driver is looking at if the source is not viewable via the display the driver is looking at.

According to another embodiment, the method also includes displaying a suggested action to take to respond to the notification on the display the driver is looking at. The controller may determine the suggested action based at least in part on sensor feedback.

### BRIEF DESCRIPTION OF THE DRAWINGS

For a better understanding of the invention, the detailed description references embodiments shown in the following drawings. The components in the drawings are not necessarily to scale and related elements may be omitted to emphasize and clearly illustrate the novel features described herein. In addition, system components can be variously arranged, as known in the art. In the drawings, like referenced numerals may refer to like parts throughout the different drawings unless otherwise specified.

FIG. 1 is a block diagram of one example embodiment of a vehicle incorporating one example embodiment of a notification system of the present disclosure.

FIG. 2 is a flowchart of one example method of operating the notification system of the present disclosure.

FIGS. 3A, 3B, and 3C show how the display devices of the notification system of FIG. 1 operate in one example scenario.

### DETAILED DESCRIPTION OF EXAMPLE EMBODIMENTS

Vehicle Notification System Including Transparent and Mirrored Displays

While the notification system of the present disclosure may be embodied in various forms, the drawings show and this specification describes some exemplary and non-limiting embodiments of the notification system. The present disclosure is an exemplification of the notification system and does not limit the notification system to the specific illustrated and described embodiments. Not all of the depicted or described components may be required, and some embodiments may include additional, different, or fewer components. The arrangement and type of components may vary without departing from the spirit or scope of the claims set forth herein.

Various embodiments of the vehicle notification system of the present disclosure (sometimes referred to as the “notification system” for brevity) use an eye tracker to monitor a vehicle driver's line-of-sight to determine whether the driver is looking at a transparent display device—which functions as the vehicle's windshield—or one of a plurality of mirror display devices—which function as the vehicle's rear view and side view mirrors. Should the notification system determine based on sensor input to display a notification, the notification system displays the notification on the display device the driver is looking at. Since the notification system displays the notification on the display device in the driver's field-of-view, it is likely that the driver will see (and respond to) the notification.

The notification system continues monitoring the driver's line-of-sight, and moves the notification to a different display device if the driver shifts her gaze to that display device. The notification system therefore ensures that the notification is displayed on whichever display device the driver is looking at. This enables the driver to continue monitoring the notification without undue effort.

Additionally, if the source of the notification—such as a car in front of the driver's vehicle slamming on its brakes—is visible via the display device the driver is looking at, the notification system controls that display device to highlight or indicate the source of the notification. This enables the driver to respond to the notification more quickly because it enables the driver to bypass searching for the source of the notification. The notification system may also display a suggested action for the driver to take in response to the notification, such as a suggestion to swerve to avoid a large pothole.

### 1. Notification System Components

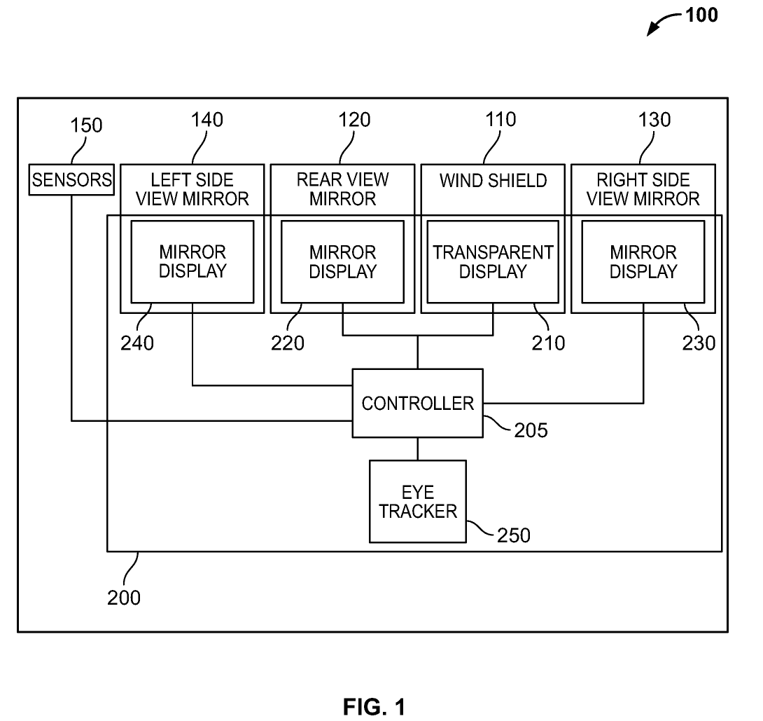

FIG. 1 is a block diagram of one example embodiment of a vehicle 100 including one example embodiment of a notification system 200 of the present disclosure. In this example embodiment, the vehicle 100 is an automobile, though in other embodiments the vehicle may be any suitable vehicle (such as a truck, a watercraft, or an aircraft). The vehicle 100 includes (among other things) a windshield 110, a rear view mirror 120, a right side view mirror 130, a left side view mirror 140, and a plurality of sensors 150. The windshield 110, the rear view mirror 120, the right and left side view mirrors 130 and 140, and the plurality of sensors 150 are directly or indirectly supported by a frame of the vehicle 100 as known in the art.

Certain of the sensors 150 are configured to obtain data about the environment surrounding the vehicle (e.g., position sensors or weather sensors), while others obtain data about components of the vehicle itself (e.g., gas level sensors or oil pressure sensors). The sensors 150 are configured to transmit the data they obtain to one or more controllers of the vehicle 100, such as the controller 205 of the notification system 200 (described below), for further processing. The sensors 150 may include any suitable sensor or sensors such as, but not limited to: (1) infrared sensors; (2) visual sensors (such as cameras); (3) ultrasonic sensors; (4) RADAR; (5) LIDAR; (6) laser-scan sensors; (7) inertial sensors (for example, an inertial measurement unit); (8) wheel speed sensors; (9) road condition sensors (to directly measure certain road conditions); (10) rain sensors; (11) suspension height sensors; (12) steering wheel angle sensors; (13) steering torque sensors; (14) brake pressure sensors; (15) tire pressure sensors; or (16) vehicle location or navigation sensors (such as a Global Positioning System).

The notification system 200 includes a controller 205, a transparent display device 210, a first mirror display device 220, a second mirror display device 230, a third mirror display device 240, and an eye tracker 250. The controller 205 is electrically connected to the transparent display device 210, the first mirror display device 220, the second mirror display device 230, the third mirror display device 240, and the eye tracker 250 such that the controller 205 can send signals to and receive signals from these components, and vice-versa.

The controller 205 includes at least one processor in communication with a memory that stores a set of instructions. The processor is configured to communicate with the memory, access the set of instructions, and execute the set of instructions to cause the notification system 200 to perform any of the methods, processes, and features described herein.

The processor may be any suitable processing device or set of processing devices such as, but not limited to: a microprocessor, a microcontroller-based platform, a suitable integrated circuit, or one or more application-specific integrated circuits (ASICs) configured to execute the set of instructions. The memory may be any suitable memory device such as, but not limited to: random-access memory (RAM), which can include non-volatile RAM, magnetic RAM, ferroelectric RAM, and any other suitable forms; disk memory; a hard disk drive (HDD); a solid state drive (SSD); FLASH memory; EPROMs; EEPROMs; memristor-based non-volatile solid-state memory; unalterable memory; or read-only memory.

The transparent display device 210 includes a screen that is see-through like glass yet can also display images. One example of a transparent display device is the Planar® LookThru™ OLED available from Planar Systems, Inc. (Planar® is a registered trademark of Planar Systems, Inc.). In this example embodiment, the windshield 110 includes the transparent display device 210.

Here, the transparent display device 210 replaces the laminated glass, composite, or other material forming a typical automobile windshield. The transparent display device 210 enables one to see through the screen like a typical automobile windshield, but provides additional functionality by enabling the notification system 200 to control the (otherwise transparent) screen to display images. In other embodiments, the transparent display device replaces only part of the material forming a typical automobile windshield or is embedded within the material forming a typical automobile windshield.

The first, second, and third mirror display devices 220, 230, and 240 includes a screen that is reflective like a mirror yet can also display images. One example of a mirror display device is the MemoryMirror available from MemoMi® Labs Inc. (MemoMi® is a registered trademark of MemoMi Labs Inc.). In this example embodiment, the rear view mirror 120 includes the first mirror display device 220, the right side view mirror 130 includes the second mirror display device 230, and the left side view mirror 140 includes the third mirror display device 240.

Here, the first, second, and third mirror display devices 220, 230, and 240 each replace the reflectively-coated glass (or other suitable material) forming typical automobile rear view and side view mirrors. The mirror display devices 220, 230, and 240 enable one to see reflections like typical automobile rear view and side view mirrors, but provide additional functionality by enabling the notification system 200 to control the (otherwise reflective) screens to display images. In other embodiments, the mirror display devices replace only part of the reflectively-coated glass (or other suitable material) forming typical automobile rear view and side view mirrors or is embedded within the reflectively-coated glass (or other suitable material) forming typical automobile rear view and side view mirrors.

The eye tracker 250 is mounted within the interior of the vehicle 100 and is configured to focus on the head of the driver of the vehicle 100 while tracking the driver's eyes. This enables the eye tracker 250 determine the driver's line-of-sight. The eye tracker 250 may be any suitable eye tracker, such as those available from Tobii® (Tobii® is a registered trademark of Tobii Technology AB) or the RED250mobile available from SensoMotoric Instruments® (SensoMotoric Instruments® is a registered trademark of SensoMotoric Instruments GmbH Limited Liability Company). In other embodiments, the notification system includes one or more devices in addition to or instead of the eye tracker to determine the driver's line-of-sight, such as a gesture tracker.

### 2. Method of Operating the Notification System

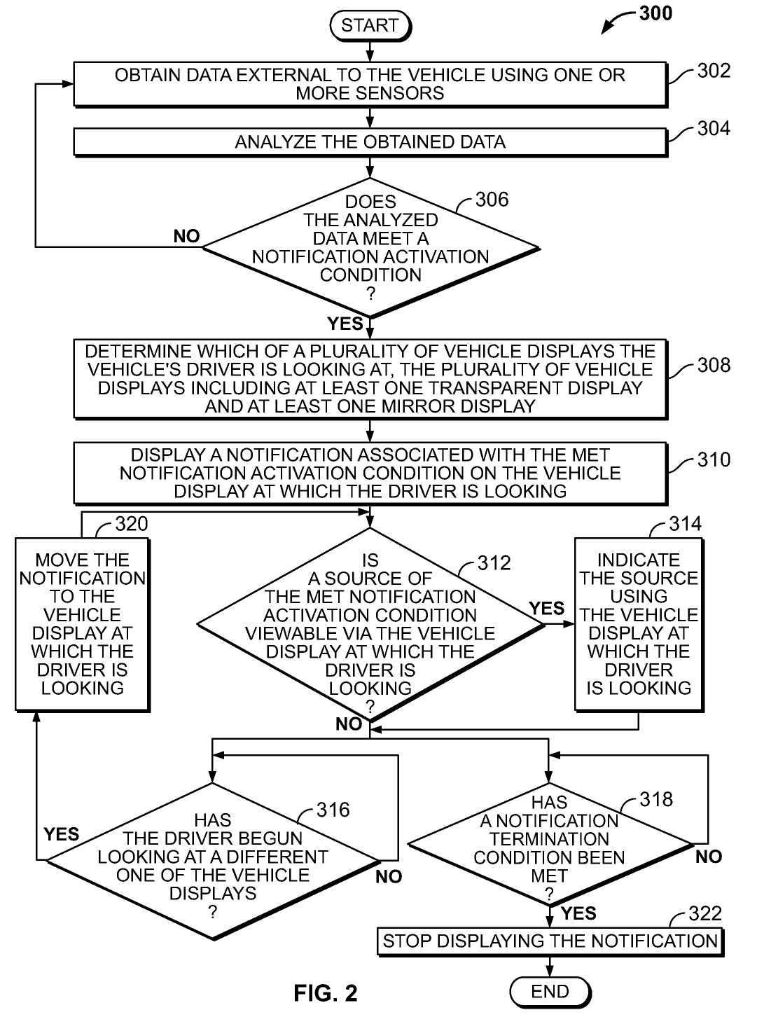

FIG. 2 is a flowchart of an example process or method 300 of operating the notification system 200 of the present disclosure. In various embodiments, the process 300 is represented by a set of instructions stored in one or more memories (such as the memory of the controller 205) and executed by one or more processors (such as the processor of the controller 205). Although the process 300 is described with reference to the flowchart shown in FIG. 2, many other processes of performing the acts associated with this illustrated process 300 may be employed. For example, the order of certain of the illustrated blocks or diamonds may be changed, certain of the illustrated blocks or diamonds may be optional, or certain of the illustrated blocks or diamonds may not be employed.

In operation of this example embodiment, the notification system obtains data external to the vehicle using one or more sensors, as indicated by block 302. For example, the sensors 150 of the vehicle 100 include a proximity sensor (such as an ultrasonic sensor, RADAR, or a laser-scan sensor) that obtains data regarding the distance between the rear bumper of the vehicle 100 and any objects surrounding the vehicle within the proximity sensor's range. The proximity sensor sends this data to the controller 205 of the notification system 200.

The notification system analyzes the obtained data, as indicated by block 304, and determines whether the analyzed data meets a notification activation condition, as indicated by diamond 306. A notification activation condition is a condition that, if met, results in the notification system displaying a notification one of the vehicle display devices. The controller 205 of the notification system 200 stores in its memory (or can otherwise access) a database including a plurality of different notification activation conditions, and analyzes the data in view of each notification activation condition in the database (or each of a subset of the notification activation conditions, such as each notification activation condition associated with that particular sensor or type of sensor) to determine if any notification activation condition is met. For instance, continuing with the above example, one notification activation condition is met when an object (such as another vehicle, a mailbox, a telephone pole, etc.) is within a designated proximity of the rear bumper of the vehicle 100.

If at diamond 306 the notification system determines that a notification activation condition has not been met, the process 300 returns to block 302. If, on the other hand, at diamond 306 the notification system determines that a notification activation condition has been met, the notification system determines which of a plurality of vehicle display devices the vehicle's driver is looking at, as indicated by block 308. Specifically, the notification system uses the eye tracker to determine the line-of-sight of the vehicle's driver. The eye tracker sends the determined line-of-sight to the controller. The controller uses that determined line-of-sight to determine which of the vehicle display devices the driver is looking at.

Continuing with the above example, the controller 205 determines based on the data obtained by the proximity sensor that a mailbox is within the designated proximity of the rear bumper of the vehicle 100 and therefore determines that the notification activation condition has been met. The eye tracker 250 determines the line-of-sight of the driver of the vehicle 100 and sends this information to the controller 205. The controller 205 determines based on the determined line-of-sight that the driver is looking at the third mirror display 240 of the left side view mirror 140.

After determining which vehicle display device the vehicle's driver is looking at, the notification system displays a notification associated with the met notification activation condition on that particular vehicle display device, as indicated by block 310. For instance, continuing with the above example, the notification system 200 controls the third mirror display 240 (which the driver is looking at) to display a notification associated with the fact that the mailbox is close to the rear bumper of the vehicle 100.

The notification may be any suitable notification including text, images, video, or any suitable combination thereof, and may be accompanied by a non-visual notification or notifications, such as an audible indication (e.g., a chime) or a tactile notification (e.g., vibrating steering wheel or seat). In certain embodiments, the notification is somewhat transparent or translucent such that the driver can: (1) if displayed on the transparent display, see through the notification; and (2) if displayed on one of the mirror displays, see the reflection in the mirror display behind the notification. In other embodiments, the notification is opaque such that the notification: (1) if displayed on the transparent display, prevents the driver from seeing through the part of the transparent display displaying the notification, and (2) if displayed on the mirror display, prevents the driver from seeing the reflection in the portion of the mirror display displaying the notification.

The notification system determines if a source of the met notification activation condition is viewable via the vehicle display device the vehicle's driver is looking at, as indicated by diamond 312. For instance, continuing with the above example, the notification system 200 determines if the mailbox (i.e., the source of the met notification activation condition) is viewable via the third mirror display device 240 (which the driver of the vehicle 100 is looking at).

If so, the notification system indicates the source of the met notification activation condition viewable via that particular vehicle display device in a suitable manner, as indicated by block 314, and the process 200 proceeds to diamonds 316 and 318, described below. For instance, continuing with the above example, if the mailbox is viewable via the third mirror display device 240, the notification system 200 controls the third mirror display device 240 to display a red flashing border around the mailbox. The process 300 then proceeds to diamonds 316 and 318, as described below. The notification system may indicate the source in any suitable manner, such as by encircling the source, inscribing the source within a box, displaying a flashing indicator, displaying an arrow pointing to the source, or any suitable combination thereof.

Once the notification system begins displaying a notification on one of the vehicle display devices, the notification system continues to display the notification until either: (1) the driver looks away from that vehicle display device and to another vehicle display device, in which case the notification system moves the notification to that other vehicle display device; or (2) a notification termination condition is met, in which case the notification system stops displaying the notification.

More specifically, after displaying any indication of the source of the met notification activation condition, the notification system: (1) determines whether the vehicle's driver has begun looking at a different vehicle display device, as indicated by diamond 316; and (2) determines whether a notification termination condition has been met, as indicated by diamond 318.

If the notification system determines at diamond 316 that the vehicle's driver has not begun looking at a different vehicle display device, the notification system repeats diamond 316. If, on the other hand, the notification system determines at diamond 316 that the driver has begun looking at a different vehicle display device, the notification system moves the notification from the vehicle display device the driver was previously looking at to the vehicle display device that the driver is currently looking at, as indicated by block 320. The process 300 then returns to diamond 312. Put differently, the notification system continuously monitors to determine whether the driver begins looking at a different vehicle display device and, if so, dynamically moves the notification to that vehicle display device. In certain embodiments, the notification system does not stop displaying the notification on the vehicle display device the driver was initially looking at.

For instance, continuing with the above example, the controller 205 continuously analyzes the determined line-of-sight of the driver the eye tracker 250 provides to determine if and when the driver begins looking at the transparent display device 210, the first mirror display device 220, or the second mirror display device 230 instead of the third mirror display device 240. If the driver begins looking at the transparent display device 210 instead (or the first mirror display device 220 or the second mirror display device 230) of the third mirror display 240, the controller 205 controls the third mirror display device 240 to stop displaying the notification and controls the transparent display device 210 (or the first mirror display device 220 or the second mirror display device 230) to begin displaying the notification instead.

Each notification activation condition is associated with a notification termination condition that, if met, causes the notification system to stop displaying the notification associated with the met notification activation condition. If the notification system determines at diamond 318 that a notification termination condition has not been met, the process 300 repeats diamond 318. If, on the other hand, the notification system determines at diamond 318 that a notification termination condition has been met, the notification system stops displaying the notification, as indicated by block 322, and the process ends. Put differently, the notification system monitors to determine whether the notification termination condition has been met, and stops displaying the notification when the notification termination condition is met.

For instance, continuing with the above example, the notification activation condition met when an object is within a designated proximity of the rear bumper of the vehicle 100 is associated with a notification termination condition met when the object is no longer within the designated proximity of the rear bumper of the vehicle 100. The controller 205 continuously monitors the data obtained by the sensors 150 to determine whether the vehicle 100 moves such that the mailbox is no longer within the designated proximity of the rear bumper of the vehicle 100 (i.e., to determine whether the notification termination condition is met). Once the mailbox is no longer within the designated proximity of the rear bumper of the vehicle 100 (i.e., once the notification termination condition is met), the controller 205 controls the transparent display device 210 (which the driver is looking at) to stop displaying the notification.

In certain embodiments, the notification system further tailors the display of notifications by using the determined field-of-view of the driver to determine which portion of a particular vehicle display device the driver is looking at and displaying the notification in that particular portion of the vehicle display device. For instance, if the notification system determines that the driver is looking out of the bottom left quadrant of the transparent display, the notification system displays the notification in the bottom left quadrant of the transparent display.

### 3. Example Operation

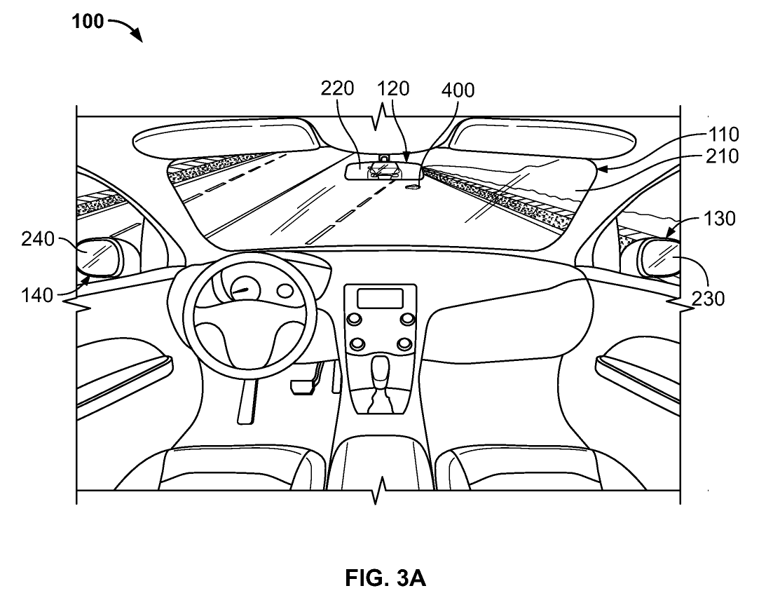

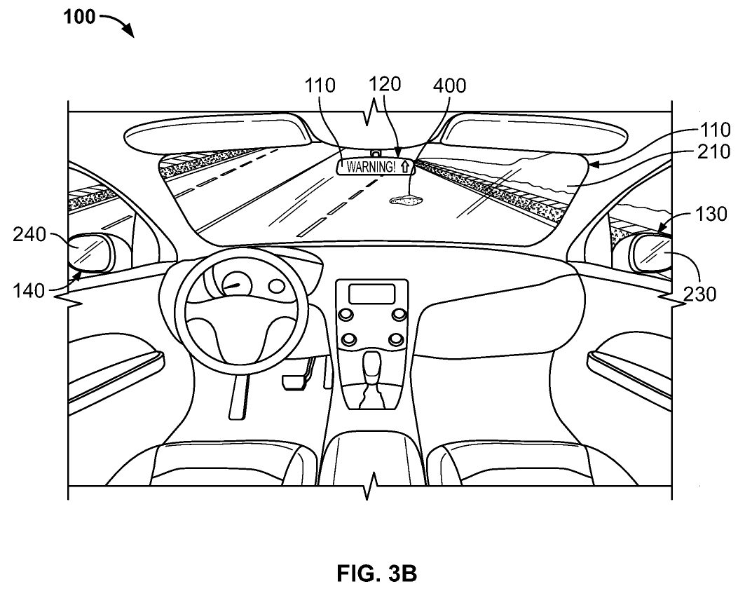

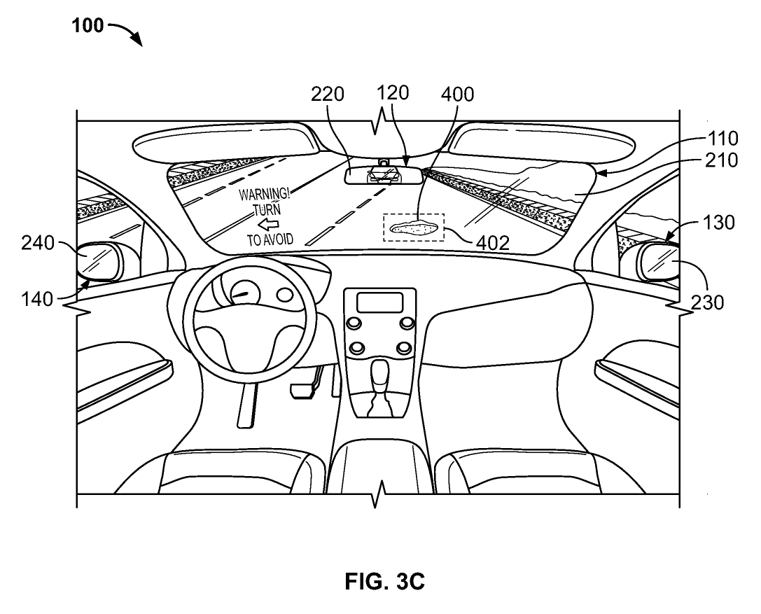

FIGS. 3A, 3B, and 3C show how the notification system 200 of the vehicle 100 operates in one example scenario. As shown in FIG. 3A, the vehicle 100 is approaching a pothole 400 in the path of the vehicle 100. The controller 205 of the notification system 200 obtains data regarding the pothole 400 from the one or more sensors 150, such as a front-facing camera or RADAR. The controller 205 analyzes the obtained data and determines whether any notification activation conditions are met by comparing the data to a database including a plurality of different notification activation conditions. Here, one notification activation condition is met when a pothole of at least a designated width is located in the path of the vehicle 100. In this instance, the controller 205 determines that this notification condition is met because the width of the pothole 400 is greater than the designated width and the pothole 400 is in the path of the vehicle 100.

In response, the controller 205 determines which of the transparent display device 210, the first mirror display device 220, the second mirror display device 230, and the third mirror display device 240 the driver of the vehicle 100 is looking at. Here, the eye tracker 250 determines the driver's line-of-sight and sends this information to the controller 205. The controller 205 determines based on the determined line-of-sight that the driver is looking at the first mirror display device 220 of the rear view mirror 120.

As shown in FIG. 3B, after determining that the driver is looking at the first mirror display 220, the controller 205 controls the first mirror display to display a notification associated with the met notification activation condition. Here, the notification includes text—“WARNING!”—along with an arrow indicating the general location of the pothole 400 (i.e., the source of the met notification activation condition). Since the source of the met notification condition—the pothole 400—is in front of the vehicle 100, the pothole 400 is not viewable via the first mirror display device 220, the notification system does not indicate the pothole 400 on the first mirror display device 220.

After controlling the first mirror display device 220 to display the notification, the notification system 200 continues to control the first mirror display device 220 to display the notification until either: (1) the driver looks away from the first mirror display device 220 and to another vehicle display device; or (2) a notification termination condition is met.

As shown in FIG. 3C, the controller 205 has determined (by analyzing the determined line-of-sight of the driver that the eye tracker 250 provides) that the driver has begun looking at the transparent display device 210 rather than the first mirror display device 220. Accordingly, the controller 205 controls the first mirror display device 220 to stop displaying the notification and controls the transparent display device 210 to begin displaying the notification instead. That is, the controller 205 dynamically moves the notification from the display device the driver was previously looking at to the display device the driver is currently looking at.

Since the source of the met notification activation condition—the pothole 400—is viewable via the transparent display device 210, the controller 205 controls the transparent display device 210 to indicate the pothole 400 by displaying a border 402 around the pothole 400.

In this example embodiment, the controller 205 also determines whether to display a suggested action on the display device the driver is looking at and, if so, displays the suggested action. In this example embodiment, the controller 205 determines it is appropriate to do so, and displays the text “TURN [symbol] TO AVOID” on the transparent display device 210 (which the driver is looking at) to suggest that the driver turn left to avoid the pothole 400.

The controller 205 may determine whether to display the suggested action based on feedback from various sensors or other vehicle control systems. For instance, the notification system may determine to suggest that the driver turn rather than brake to avoid an obstacle if another vehicle is tailgating the driver's vehicle. On the other hand, the notification system may determine to suggest that the driver brake rather than turn to avoid an obstacle if another vehicle is in the lane next to the driver's vehicle.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle notification system comprising:
a transparent display;
a mirror display;
an eye tracker; and
a controller configured to:
determine which display a vehicle driver is looking at using the eye tracker;
control that display to display a notification and, if a notification source is viewable via that display, control that display to indicate the source; and
if the driver begins looking at another display, control the other display to display the notification.

2. The vehicle notification system of claim 1, wherein the eye tracker is configured to monitor the eyes of the driver and determine a line-of-sight of the driver.

3. The vehicle notification system of claim 2, wherein the controller is configured to use the line-of-sight of the driver to determine which display the driver is looking at.

4. The vehicle notification system of claim 1, which includes a plurality of mirror displays.

5. The vehicle notification system of claim 4, wherein a first mirror display is part of a rear view mirror of the vehicle, a second mirror display is part of a side view mirror of the vehicle, and the transparent display is part of a windshield of the vehicle.

6. The vehicle notification system of claim 1, wherein the controller is configured to, if the source is not viewable via the display the driver is looking at, control the display the driver is looking at to display an indication associated with a location of the source.

7. The vehicle notification system of claim 1, wherein the controller is configured to control the display the driver is looking at to display a suggested action to take to respond to the notification.

8. The vehicle notification system of claim 7, wherein the controller is configured to determine the suggested action based at least in part on sensor feedback.

9. The vehicle notification system of claim 1, wherein the controller is configured to determine whether to display the notification based on sensor feedback.

10. The vehicle notification system of claim 1, wherein the controller is configured to: determine whether to display the notification based on sensor feedback; if the source is not viewable via the display the driver is looking at, control the display the driver is looking at to display an indication associated with a location of the source; and control the display the driver is looking at to display a suggested action to take to respond to the notification.

11. A method of operating a vehicle notification system comprising:
determining, by a controller and based on information obtained using an eye tracker, whether a vehicle driver is looking at a transparent display or a mirror display;
displaying a notification on that display and, if a notification source is viewable via that display, indicating the source using that display; and
if the driver begins looking at another display, displaying the notification on the other display.

12. The method of claim 11, which includes monitoring, by the eye tracker, the eyes of the driver and determining, by the eye tracker, a line-of-sight of the driver.

13. The method of claim 12, which includes determining, by the controller, which display the driver is looking at using the line-of-sight of the driver.

14. The method of claim 11, wherein the vehicle includes a plurality of mirror displays.

15. The method of claim 14, wherein a first mirror display is part of a rear view mirror of the vehicle, a second mirror display is part of a side view mirror of the vehicle, and the transparent display is part of a windshield of the vehicle.

16. The method of claim 11, which includes, if the source is not viewable via the display the driver is looking at, displaying an indication associated with a location of the source on the display the driver is looking at.

17. The method of claim 11, which includes displaying a suggested action to take to respond to the notification on the display the driver is looking at.

18. The method of claim 17, which includes determining, by the controller, the suggested action based at least in part on sensor feedback.

19. The method of claim 11, which includes determining, by the controller, whether to display the notification based on sensor feedback.

20. The method of claim 11, which includes: determining, by the controller, whether to display the notification based on sensor feedback; if the source is not viewable via the display the driver is looking at, displaying an indication associated with a location of the source on the display the driver is looking at; and display a suggested action to take to respond to the notification on the display the driver is looking at.
